(19) United States
(12) Patent Application Publication
(10) Pub. No.: US 2009/0245516 A1
(43) Pub. Date: Oct. 1, 2009

(54) Method and system for high entropy encryption using an unpredictable seed based on user regisration time

(76) Inventor: Pasupuleti Sureshbabu Ravikiran, Chennai (IN)

Correspondence Address: ALIX YALE & RISTAS LLP, 750 MAIN STREET, SUITE 1400, HARTFORD, CT, 06103, US

(21) Appl. No.: 12/380,233

(22) Filed: Feb. 25, 2009

(30) Foreign Application Priority Data
Feb. 26, 2008 (IN) 470/CHE/2008

(51) Int. Cl. H04L 9/00; H04L 9/28

(52) U.S. Cl. 380/268; 380/28

(57) ABSTRACT

A method of encryption of data for transmission in a secured manner over a communication channel. The encoding key is continually changed in response to each packet of data encoded, depending on a Seed Key and time stamping of data packets or a pseudo random sequence generated using synchronized clocks.

### RELATED APPLICATION

This application claims priority under 35 U.S.C. 119(a) from Indian Patent Application No. 470/CHE/2008 filed Feb. 26, 2008 for “Method And System For High Entropy Encryption Using An Unpredictable Seed Based On User Registration Time”, the entire disclosure of which is hereby incorporated by reference.

### FIELD OF THE INVENTION

The present invention relates to a method of encryption of data for transmission in a secured manner over a communication channel. More particularly, the invention is directed to a method that continually changes the encoding key in response to each packet of data encoded, depending on a Seed Key and time stamping of data packets or a pseudo random sequence generated using synchronized clocks.

### BACKGROUND ART

It is a common experience in the field of data security in systems for various communication channels, that there perpetually exists the problem of securely protecting information from susceptibility to third-party interception, eavesdropping, compromise and/or corruption. Traditionally, this problem has been confronted with and means explored to resolve through the technological development over the years through increasingly sophisticated cryptographic techniques. Cryptography typically involves converting data from an understandable form into an encrypted form which cannot be understood by persons other than the intended recipient, and transmitting the data to the recipient who deciphers the data. It would be clearly apparent that the related prior arts describe these techniques involving the use of key-based ciphers. But, the advanced computing technology as it stands today, it is easy to break a cipher without prior knowledge of its key. Any problem that might have consumed years of continual computing effort a decade ago can now be accomplished in a very small fraction of such time. Therefore encryption of data has become an important aspect of data security in present day requirement of data communication.

Encryption of data is usually accomplished by applying an algorithm to that data, and decryption is accomplished by applying the inverse of that algorithm. In many cases, the encryption step involves a “pass phrase” or key, which is combined with the data according to the algorithm to create the encrypted message. In the prior art systems and methods, it has been possible to encrypt all programs according to a single encryption system. However, encrypting all the programs identically does not allow program-by-program access control. Separate encryption for each program according to the known prior art, therefore, required a separate decoding apparatus for receiving and executing the multiple keys for each of the separate programs. The multiple key mechanisms for separately decoding multiple programs at receiver units involved the cumbersome and expensive necessity of separate decoders, separately executing separate keys for each of the programs.

It is also experienced in actual implementation of prior art systems and methods, that when the key space is extremely large, the encryption system is said to have high encryption intensity and the decryption of it is said to be computationally infeasible. Attempts have been made in the prior art to provide for a secret key cryptographic system. However all such systems cannot easily and accurately evaluate the actual security of the system. Also, the user has no systematic way to modify the algorithm or transformations to make the system more secure or to increase the encryption intensity. In any case, it appears that the encryption intensity cannot be increased without incurring an exponential increase in computing overheads. This is why the existing systems rely on the principle of computationally intense algorithms to achieve encryption and here the same short key is used many times but under different conditions to encrypt a much longer plaintext.

Other prior art systems relies on the principle of computationally complex algorithms to achieve encryption. In such system, a user picks up two very large prime numbers, preferable a few hundred digits each, to generate a pair of dissimilar encryption and decryption keys. Encryption is performed as exponentiation under modulo arithmetic control by the encryption key. The undesirable feature in such method is that the security of the system is based on the use of very large prime numbers that are not easy to obtain. Also, the system can be easily defeated if a quick way to factorize the product of two large prime number is discovered.

Other conventional encryption systems use random number generator to encrypt a stream of data. So long as the random number stream is not known, the resulting output data also looks like a stream of random numbers. The principal way to crack the code is to learn how to recreate the random number stream and the encrypted data stream with this random number stream, thereby regenerating the original data. Also it is possible in such systems to have an understanding of the meaning of a message without fully decrypting the message.

U.S. Pat. No. 7,333,611 is a patent that talks about using a quantum noise to discourage the attacker from making meaningfulness of any sniffed packet. This patent thus involves noise as detection means to ensure secured communication. While the present invention is about deriving randomness from the time elapsed from registration using time offset and encrypting the message with a pseudo random key generated using such time offset.

U.S. Pat. No. 7,120,249 is a prior patent directed to use of a master secret and random seed to encrypt data packets wherein the random seed is sent by the sender in an unencrypted format along with the data packet. The receiver uses this with the master key to create a one-way hash to arrive at the actual key for decryption. The present invention is distinguished in the meaning of associating time stamped data and seed key for securing packets of data wherein use encryption system steps using Time and Pseudo Random Sequence, wherein a hash can be generated combining the Seed key and Pseudo Random number and this hash can be used as the encryption key.

U.S. Pat. No. 7,089,426 is a patent that relates to asymmetric encryption using hardware components for media industry. The present invention does not make use of any hardware device for encryption/decryption purpose.

U.S. Pat. No. 7,346,167 is a prior patent directed to wireless communication using seed generators wherein both the data and the key are exchanged with the receiver. The present invention does not require exchanging keys between the end users during a communication session.

U.S. Pat. No. 7,212,634 is a patent about multicast videos and the seed/keys to decrypt the video content being sent to the customer unit along with the video/separately i.e key exchange takes place over the network. The present invention does not require exchanging keys between the end users.

U.S. Pat. No. 7,170,996 is a patent directed to derive randomness from signal offsets, and using this random number to generate a key for encryption. The present invention does not relate to signal offsets, but derives randomness from the time elapsed from registration corresponding to a data packet.

U.S. Pat. No. 7,127,619 is a patent directed to reducing the bandwidth consumption requirements for multiple CA systems, using partial encryption of Audio/SI information. The present invention is distinguished from this prior art in the sense it relates to exchange of information, without the need to exchange the encryption keys and instead using the inherent human entropy factor for the randomness.

U.S. Pat. No. 7,209,561 is a patent that discloses generation of a theoretically truly random key for symmetric encryption, using current time, hash values and a few iterations of processes. This prior art is different in inventive intent in a sense that although the present invention is also about symmetric encryption, but it uses the time ‘offset’ from registration to derive the randomness for the KEY generation corresponding to a data packet and uses the inherent human entropy factor for the randomness, without exchanging the encryption keys.

There has been thus a need in the art for text/data communication, to develop adequately securing encryption system that overcomes all the deficiencies and disadvantages of the prior art systems mentioned above, in a simple, fast and cost effective manner which would avoid the possibilities of third-party interception, eavesdropping, compromise and/or corruption during message/data dissemination to intended recipient. The method and the system would provide means wherein the user would be capable of easy and accurate evaluation of the actual security of the system. Moreover, such encryption system would not involve the complexity of decryption of encrypted data computationally infeasible because of high encryption intensity due to extremely large key space. Further, the encryption system would on one hand avoid use of computationally complex algorithms based on large prime numbers to generate a pair of dissimilar encryption and decryption keys, and on the other hand need not modify the algorithm or transformations to make the system more secure or increasing the encryption intensity or use of repeating short keys in many forms while encrypting large plain-text, without incurring an exponential increase in computing overheads, enabling data communication in crack safe manner with enhanced security, thus favoring application of such encryption method for data security in a number of end applications comprising the mobile messaging, consumer devices e.g. STB or Network devices or Client-server or peer-to-peer communication where key exchange is not desirable.

### OBJECTS OF THE INVENTION

It is thus the basic object of the present invention to provide a method providing secured manner of data communication involving Seed Key and time stamping of data packets or a pseudo random sequence generated using synchronized clocks such that the possibilities of third-party interception, eavesdropping, compromise and/or corruption during message/data dissemination to intended recipient is avoided.

Another object of the present invention is directed to achieve a method for secured data communication wherein the user is capable of easy and accurate evaluation of the actual security of the system.

Another object of the present invention is directed to achieve a method for secured data communication wherein the encryption system would not involve the complexity of decryption of encrypted data computationally infeasible because of high encryption intensity, or due to extremely large key space.

A further object of the present invention is directed to achieve a method for secured data communication wherein the encryption system would on one hand avoid use of computationally complex algorithms based on large prime numbers to generate a pair of dissimilar encryption and decryption keys.

A further object of the present invention is directed to achieve a method for secured data communication wherein use of separate decoding apparatus for receiving and executing the multiple keys for each of the separate programs are avoided and also the cumbersome and expensive necessity of separate decoders involved at receiver units, separately executing separate keys for each of the programs in case of multiple key mechanisms for separately decoding multiple programs are eliminated.

A still further object of the present invention is directed to achieve a method for secured data communication wherein said method provide means for transmitting data securely over any medium using any symmetric key cryptography where the keys are changed constantly and are never exchanged between the sender and receiver during the encryption session.

A still further object of the present invention is directed to achieve a method for secured data communication wherein the Time of Registration (TR) is recorded by both the parties independently, using a synchronized clock mechanism, such that at any instant in a session, the Time Elapsed (TE) from registration is considered as the SEED.

A still further object of the present invention is directed to achieve a method for secured data communication wherein the data is to be transmitted to the sender and receiver use same standard time say (GMT) as a point of reference.

A further object of the present invention is directed to achieve a method for secured data communication wherein the SEED is used to construct a pseudo random number called the KEY, to be associated with or used to encrypt a data packet/message from sender for secured communication.

A still further object of the present invention is directed to achieve a method for secured data communication wherein the receiver gets the encrypted message, which contains the Sender's ‘Sent time stamp’ and can compute the same KEY independently from the sent time's offset from registration accurately even in presence of possible Network Latency, and the same key is used for decrypting the message by the receiver, thus maintaining the end to end security of such communication.

Another further object of the present invention is directed to achieve a method for secured data communication wherein the date/time of Registration is a user triggered action, and is highly unpredictable having inherent human entropy component and which is used as the random factor for encryption.

A still further object of the present invention is directed to achieve a method for secured data communication wherein the keys change periodically, say in every minute or for each data packet where the change in interval could be configured, such that undesired human interception is avoided.

### SUMMARY OF THE INVENTION

Thus according to the basic aspect of the present invention is thus directed to a method of encryption of data for transmission and reception in a secured manner over a communication channel comprising:
generating a Seed Key and exchanging the Seed key between the sender and receiver;
the sender continually changing and generating encryption key based on the seed key and time or pseudo random sequence in response to each packet of data encoded and transmitted;
the receiver generating the decryption key based on the same seed key and time or pseudo random sequence based encryption to thereby decrypt the encoded data packet.

Another aspect of the present invention is directed to a method of encryption of data wherein said pseudo random sequence is generated by a pseudo random sequence generator along with synchronized clocks for the stated encoding and decoding process. A further aspect of the present invention is directed to a method of encryption of data wherein the data transmission is carried out securely over any medium involving any symmetric key cryptography where the keys are changed constantly and are never exchanged between the sender and receiver during the encryption session.

A further aspect of the present invention is directed to a method of encryption of data wherein the keys are sent ahead of time to the sender and receiver through secure means.

A still further aspect of the present invention is directed to a method of encryption of data wherein the data is transmitted to the sender and receiver involving the same standard time preferably GMT as a point of reference.

A still further aspect of the present invention is directed to a method of encryption of data wherein the encryption key for forwarding data is derived from said seed key and the GMT involving any standard forwards including Hashing Algorithms.

A further aspect of the present invention is directed to a method of encryption of data wherein the decryption key is generated based on the said seed key and time (GMT) based information at the receivers end.

According to an advantageous aspect of the present invention is directed to a method of encryption of data wherein the data is spliced and sent in different packets.

A still further aspect of the present invention is directed to a method of encryption of data comprising for enhanced security following the steps of:
(a) synchronizing the sender and the receiver clocks at a random time such that it introduces another variable into the encryption scheme (High Entropy) and once the clocks are synchronized a Pseudo random number is generated preferably periodically at the both ends;
(b) generating a hash combining the seed key and the pseudo random number as the encryption key.

According to yet another aspect of the present invention directed to said method of encryption comprising introducing added information available with only the sender and the receiver about the Hashing function.

Importantly also according to an aspect of the present invention directed to said method of encryption of data wherein the exchange of seed key is done in a medium other than the medium of data exchange.

According to a further aspect of the method of encryption of data according to the present invention comprises:
i) sender and receiver exchanging said Seed Key.
ii) said sender generating a hash based on the GMT (T) and the seed key (SK1) and encrypting the message M to generate cipher text M′.

K=Fₕ(SK1,T)
Where K is the encryption key
Fₕ is the Hashing Function (MD5 SHA etc)
SK1 is the Seed Key and T is the Time.

M′=Fₑ(M,K)
Where M is the message.
Fₑ is the symmetric encryption function (RSA etc).
iii) forwarding the Cipher Text M′ over the primary communication channel.
iv) at the receiving end the decryption Key is generated using the same method.

K=Fₕ(SK1,T)
Where K is the encryption key
Fₕ is the Hashing Function (MD5 SHA etc)
SK1 is the Seed Key and T is the Time.

M=Fᵤ(M′,K)
where M is the message and Fᵤ is the symmetric decryption function (RSA etc).

A still further aspect of the present invention is directed to a system for carrying out the method of encryption of data for transmission and reception in a secured manner over a communication channel comprising:
means adapted for generating a Seed Key and exchanging the Seed key between the sender and receiver;
means at the sender's end adapted for continually changing and generating encryption key based on the seed key and time or pseudo random sequence in response to each packet of data encoded and transmitted;
means at the receiver's end adapted for generating the decryption key based on the same seed key and time or pseudo random sequence based encryption to thereby decrypt the encoded data packet.

Another aspect of the system according to the present invention wherein said communication of seed and data is accomplished through any suitable network.

Also in the system according to the present invention wherein said means for sending and receiving seed and/or data comprises anyone or more of mobile communication such as mobile SMS communication, consumer devices such as STB, network devices and the like.

A still further aspect of the present invention is directed to a system wherein said means for sending and receiving seed and/or data comprises client-server or peer-to-peer communication where key exchange is not desired.

The present invention and its objectives and advantages are described in greater details with reference to the accompanying non limiting illustrative drawing.

### BRIEF DESCRIPTION OF THE ACCOMPANYING FIGURE

FIG. 1: is the schematic diagram illustrating the method of secured data/message communication involving time registration and senders time stamped data encrypted with ‘Seed’ or ‘Key’ based on time offset and pseudo random number, and secured communication without exchange of key to intended receiver and decryption using computed Key based on elapsed time from time registration/offset.

### DETAILED DESCRIPTION OF THE INVENTION WITH REFERENCE TO THE ACCOMPANYING FIGURE

The present invention is directed to a method for secured transmission for data/message communication using time stamped encryption key attached to sequential data packets for such communication from sender to receiver without any exchange of encryption key between the sender and receiver, although the encryption key may be changed many times at evenly spaced interval in a data communication session in order to avoid undesired third party interception.

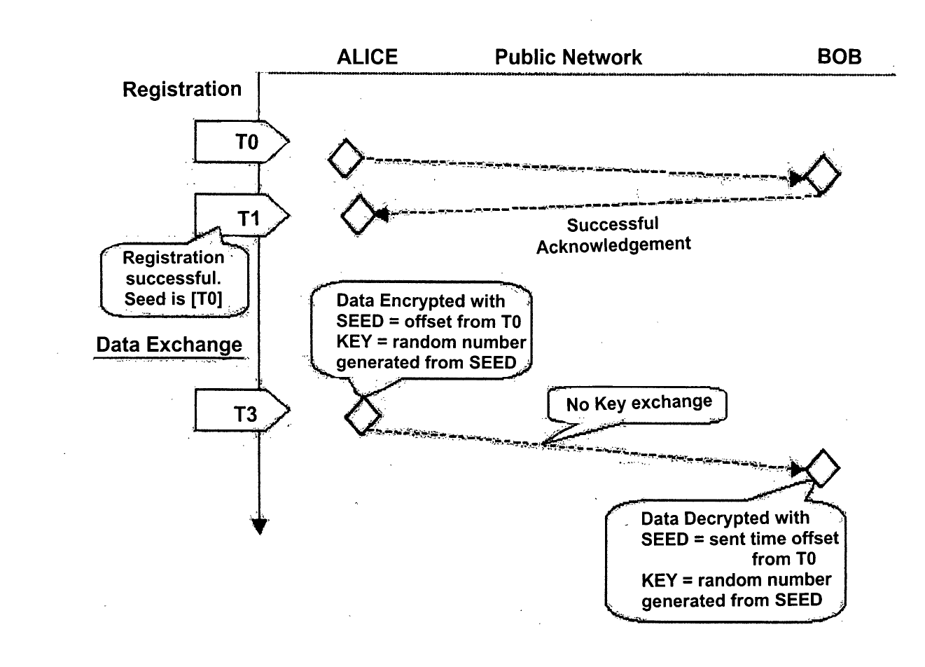

Attention is first invited to the accompanying FIG. 1, that schematically illustrates the method of registration and time stamping of data packet, secure communication by the sender attaching each such data pack to a Seed key as a pseudo random number, receiving the message/data by the receiver and decrypting the same by using key computing from the seed and time elapsed with respect to registration.

As already described, the present invention relates to a method of encryption of sensitive data for transmission in a secured manner over a communication channel. This invention relates to symmetric key encryption without ever exchanging the key between parties, using High Entropy. The first communication between parties is called the process of Registration. This starts the pseudo random generator on both ends. A successful registration by the sender is SEED or T0 and its acknowledgement by the receiver is T1. The Time of Registration (TR) is recorded by both the parties independently, using a synchronized clock mechanism. The date/time of Registration is a user triggered action, and is highly unpredictable. This unpredictability is used as the random factor for encryption. At any instant, the Time elapsed (TE) from registration is considered as the SEED. The SEED is then used to construct a pseudo random number called the KEY. This KEY is used to encrypt the message from sender. Thus for any data exchange at any instant T3, the seed key is based on time offset from T0 and key is the random number generated from seed. If registration SEED is lost, a simple process of Registering again could be done. Receiver gets the encrypted message, which contains the Sender's ‘Sent time stamp’. Receiver can compute the same KEY independently from the sent time's offset from registration. Encryption keys are never exchanged between parties. The keys change periodically (every minute) or (for each data packet); where the change interval could be configured. Receiver can compute the same KEY independently from the sent time's offset from registration. The accuracy of the data transmission or time computation based decryption at receiving end is not sacrificed even in case of network latency in case of any network based data transmission. Due to this mechanism, the message need not be resent once received.

The method described continually changes the encoding key in response to each packet of data encoded, depending on a Seed Key and time lapsed and a pseudo random sequence generated using synchronized clocks. The method and system of encryption of sensitive data allow transmission in a secured manner over a communication channel. The method of encryption of sensitive data allow encoding key to change continuously in response to each packet of data encoded at selective time intervals, in order to have unique impenetrable identity and inaccessibility to the data pack. A Seed Key is used in the data encryption method to encode and decode data. The present method for secured data communication wherein the Time of Registration (TR) is recorded by both the parties independently, using a synchronized clock mechanism, such that at any instant in a session, the Time Elapsed (TE) from registration is considered as the SEED. The method and system of encryption of sensitive data generates a pseudo random sequence used along with synchronized clocks for the encoding and decoding process. Advantageously also, the method of transmitting data securely over any medium using any symmetric key cryptography where the keys are changed constantly and are never exchanged between the sender and receiver during the encryption/communication session. Such Keys are sent ahead of time to the sender and receiver through a secure means. All the data to be transmitted to the sender and receiver use same standard time such as the GMT as a point of reference.

The actual key that is used to send the data is derived from the Seed Key and the GMT using any standard, forwards only the Hashing Algorithms. In the present method the receiver knows the seed key and the Time (GMT) to derive by computing the decryption key and decrypt the message. Also the method enable introducing added information available with only the sender and the receiver about the Hashing function.

Importantly also, the method of secured data communication of the present invention wherein the data to be transmitted can be spliced and sent in different packets.

The preceding description sufficiently define the methodology for the security of the data transmission many fold because each packet of data transmitted is encrypted using a different key and even if one message is decrypted using the brute force method, chances of decrypting the next message almost impossible because the key for the next packet is completely different and this key cannot be derived from the key of the previous packets therefore the data in the packet will be incomplete and totally meaningless. So the maximum size of the data fragment that can be decrypted is further reduced. This method is thus very effectively used for encryption of data and is also very sensitive and cannot be decrypted using brute force. The man in the middle attack can easily be foiled because even after collecting enough packets of data, the key sequence cannot be predicted.

The security of data communication is enhanced further in certain application by allowing the sender and receiver to synchronize their clocks at a random time so that this introduces another truly completely random variable into the encryption scheme High Entropy. Once the clocks are synchronized a Pseudo random number can be generated, say periodically at intervals of every few micro seconds to minutes, at both the ends. A hash can be generated combining the Seed key and Pseudo Random number and this hash is used as the encryption key.

While the accompanying FIG. 1 illustrates an embodiment of the method of Encrypted key based secured communication of message/data, using any communication channel, between the sender and receiver in general, the method according to the invention is directed to use either Encryption System Steps using Time or using both Time and Pseudo Random Sequence.

A. The steps involved in Encryption system steps using time comprise:
1) Sender and receiver exchange the Seed Key. These can be done in a medium other than the medium of data exchange. So for example if the data needs to be transmitted over the internet the key exchange can happen over mail or an ATM terminal etc. say SK1;
2) When the Data needs to be transmitted the sender generates a hash based on the GMT (T) and the seed key (SK1) and encrypts the message M to generate cipher text M′.

K=Fₕ(SK1,T)
Where K is the encryption key
Fₕ is the Hashing Function (MD5 SHA etc)
SK1 is the Seed Key and T is the Time.

M′=Fₑ(M,K)
Where M is the message.
Fₑ is the symmetric encryption function (RSA etc).
3) Cipher Text M′ is sent over the primary communication channel.
4) On the receiving end the Key is generated using the same method.

K=Fₕ(SK1,T)
Where K is the encryption key
Fₕ is the Hashing Function (MD5 SHA etc)
SK1 is the Seed Key and T is the Time.

### ti M=Fᵤ(M′,K)

Where M is the message and Fᵤ is the symmetric decryption function (RSA etc).
   B. The steps involved in encryption system using time and pseudo random sequence:
1) Sender and receiver exchange the Seed Key. These can be done in a medium other than the medium of data exchange. So for example if the data needs to be transmitted over the internet the key exchange can happen over mail or an ATM terminal etc. say SK1.
2) Then both the sender and receiver synchronize their time based Pseudo random Generators at a completely random time. Say by calling a telephone number.
3) When the Data needs to be transmitted the sender generates a hash based on the Pseudo random Number PN and the seed key (SK1) and encrypts the message M to generate cipher text M′.

K=Fₕ(SK1,PN)
Where PN is the pseudo random number generated periodically both at the sender and the receivers as their clocks are synchronized.
K is the encryption key
Fₕ is the Hashing Function (MDS SHA etc)
SK1 is the Seed Key

M′=Fₑ(M,K)
Where M is the message.
Fₑ is the symmetric encryption function (RSA etc).
4) Cipher Text M′ is sent over the primary communication channel.
5) On the receiving end the Key is generated using the same method.
6) K=Fₕ (SK1,PN)
   Where PN is the pseudo random number generated periodically with synchronized clocks.
   K is the encryption key
   Fₕ is the Hashing Function (MD5 SHA etc)
   SK1 is the Seed Key

M=Fᵤ(M′,K)
Where M is the message.
Fᵤ is the symmetric decryption function (RSA etc).

It is thus possible by way of the present invention to developing a means for secured data communication wherein the Time of Registration (TR) is recorded by both the parties independently, using a synchronized clock mechanism, such that at any instant in a session, the Time Elapsed (TE) from registration is considered as the SEED. The method and system of encryption of sensitive data generates a pseudo random sequence used along with synchronized clocks for the encoding and decoding process. Advantageously also, the method of transmitting data securely over any medium using any symmetric key cryptography where the keys are changed constantly and are never exchanged between the sender and receiver during the encryption/communication session. Such Keys are sent ahead of time to the sender and receiver through a secure means. All the data to be transmitted to the sender and receiver use same standard time such as the GMT as a point of reference. The security of the data transmission is enhanced many fold because each packet of data transmitted is encrypted using a different key and even if one message is decrypted using the brute force method, chances of decrypting the next message almost impossible because the key for the next packet is completely different and this key cannot be derived from the key of the previous packets therefore the data in the packet will be incomplete and totally meaningless. So the maximum size of the data fragment that can be decrypted is further reduced. This method is thus very effectively used for encryption of data and is also very sensitive and can be decrypted using brute force. The man in the middle attack can easily be foiled because even after collecting enough packets of data, the key sequence cannot be predicted. The present method of communication is thus capable of successful and safe application for number of end uses comprising mobile SMS communication, wherein users can send encrypted text messages, without Key exchange process and the receiver mobile can decrypt the message using the time offset from the registration, consumer device (STB, Network devices etc) communicating to another consumer device or to an internet server and for any client-server or peer-to-peer communication, where key exchange is not desirable.

We claim:

1. A method of encryption of data for transmission and reception in a secured manner over a communication channel comprising:
generating a Seed Key and exchanging the Seed key between the sender and receiver;
the sender continually changing and generating encryption key based on the seed key and time or pseudo random sequence in response to each packet of data encoded and transmitted;
the receiver generating the decryption key based on the same seed key and time or pseudo random sequence based encryption to thereby decrypt the encoded data packet.

2. A method of encryption of data according to claim 1 wherein said pseudo random sequence is generated by a pseudo random sequence generator along with synchronized clocks for the stated encoding and decoding process.

3. A method of encryption of data according to claim 1 wherein the data transmission is carried out securely over any medium involving any symmetric key cryptography where the keys are changed constantly and are never exchanged between the sender and receiver during the encryption session.

4. A method of encryption of data according to claim 1 wherein the keys are sent ahead of time to the sender and receiver through secure means.

5. A method of encryption of data according to claim 1 wherein the data is transmitted to the sender and receiver involving the same standard time preferably GMT as a point of reference.

6. A method of encryption of data according to claim 1 wherein the encryption key for forwarding data is derived from said seed key and the GMT involving any standard forwards including Hashing Algorithms.

7. A method of encryption of data according to claim 1 wherein the decryption key is generated based on the said seed key and time (GMT) based information at the receivers end.

8. A method of encryption of data according to claim 1 wherein the data is spliced and sent in different packets.

9. A method of encryption of data according to claim 1 further comprising the steps of:
a. synchronizing the sender and the receiver clocks at a random time such that it introduces another variable into the encryption scheme (High Entropy);
b. generating a Pseudo random number preferably periodically at the both ends once the clocks are synchronized; and
c. generating a hash combining the seed key and the pseudo random number as the encryption key.

10. A method of encryption of data according to claim 9 further comprising introducing added information available with only the sender and the receiver about the Hashing function.

11. A method of encryption of data according to claim 10 wherein the exchange of seed key is done in a medium other than the medium of data exchange.

12. A method of encryption of data comprising:
i. generating a Seed Key;
ii. exchanging said Seed Key between a sender and a receiver;
iii. said sender generating a hash based on the GMT (T) and the seed key (SK1) and encrypting the message M to generate cipher text
M′, wherein
K=Fₕ(SK1,T),
where K is the encryption key,
Fₕ is the Hashing Function (MD5 SHA etc),
SK1 is the Seed Key and T is the Time,
M′=Fₑ(M,K), where M is the message and Fₑ is the symmetric encryption function (RSA etc);
iv. forwarding the Cipher Text M′ over the primary communication channel;
v. generating the decryption Key at the receiving end using the same method, wherein
K=Fₕ(SK1,T),
where K is the encryption key,
Fₕ is the Hashing Function (MD5 SHA etc),
SK1 is the Seed Key and T is the Time,
M=Fᵤ(M′,K), where M is the message and Fᵤ is the symmetric decryption function (RSA etc).

13. A system for carrying out the method of encryption of data for transmission and reception in a secured manner over a communication channel, comprising:
means adapted for generating a Seed Key and exchanging the Seed key between the sender and receiver;
means at the sender's end adapted for continually changing and generating encryption key based on the seed key and time or pseudo random sequence in response to each packet of data encoded and transmitted; and
means at the receiver's end adapted for generating the decryption key based on the same seed key and time or pseudo random sequence based encryption to thereby decrypt the encoded data packet.

14. A system according to claim 13 wherein said communication of seed and data is through any suitable network.

15. A system according to claim 13 wherein said means for sending and receiving seed and/or data comprises any one or more of mobile communication such as mobile SMS communication, consumer devices such as STB, network devices and the like.

16. A system according to claim 13 wherein said means for sending and receiving seed and/or data comprises client-server or peer-to-peer communication where key exchange is not desired.
